(19) United States
(12) Patent Application Publication
(10) Pub. No.: US 2004/0094662 A1
(43) Pub. Date: May 20, 2004

(54) Vertical tale-off landing hovercraft

(76) Inventors: John K. Sanders JR., Costa Mesa, CA (US); J. Kenneth Sanders, Honolulu, HI (US); Arturo Jr. Aviles, Huntington Beach, CA (US); Arturo F. Aviles, Huntington Beach, CA (US)

Correspondence Address: John Kenneth Sanders, Jr., Apt. C - 212, 2775 Mesa Verde East, Costa Mesa, CA, 92626, US

(21) Appl. No.: 10/666,936

(22) Filed: Jan. 7, 2002

(51) Int. Cl. B64C 29/00

(52) U.S. Cl. 244/12.5

(57) ABSTRACT

Unusual Flying Object (UFO) with Vertical Take Off and Landing (VTOL) capabilities including foward flight with a quiet electric, battery powered, Linear Induction Magnetic Bearings (LINB) power drive used for, manned or unmanned, small cargo tansport, recreational vehicle or aerial surveillance; aerial reconnaissance, coastal surveillance, law enforcement, traffic management, estate or park patrol, geographical or geological survey, border or pipeline patrol, communications relay platform, search and rescue, media coverage support. The invention is capable of imodifications in various respects, all without departing fron the invention Accordingly, the drawings and the description are to be regarded as illustrative in nature, and not as restrictive.

### TECHNICAL FIELD

The present invention relates to nnd and unmanned aerial vehicles (UAVs). In particular to a vertical takeoff and landing (VTOL) unusual flying objects (UFOs) having a ducted propellerdisk or series of shrouded impellerdisks for providing zero and low speed horizontal and vertical thrust, and wings with vertical and horizontal stabilizers and air flow vane assembly for providing forward translational lift and thrust in high-speed flight.

### BACKGROUND OF THE INVENTION

There are generally three tyees of VTOL configurations under current development, a wing type configuration (a fuselage with rotatable wings and engines or fixed wings with vectored thrust engines for vertical and horizontal national flight), helicopter type configuration (a fuselage with a rotor mounted above which provides lift and thrust) and ducted type configuration (a fuselage with a ducted rotor system which provides translational flight, as well as vertical take-off and landing capabilities).

There is a long list of related inventions, but the most notable pioneers include the Focke-WulfFw 61 helicopter in 1936, Piasecki's G-1 tilt rotor in 1951 and Hiller who developed their first flying platform on the basis of a contract awarded in late 1953 by the Office of Naval Research (ONR) for a one-man flying platform. The machine made its first flight in February 1955, and was named the “VZ-1 Pawnee”. The Piasecki Air Jeep, U.S. Pat. No. 2,282,612, developed and flown under the U.S. Army/Navy contracts between 1957 and 1962. In the 1960's Wendell Moore developed the wellknown Rocket Belt which can still be seen at various air shows to this day. The VZ-9-AV Avrocar, U.S. Pat. No. 3,062,482, was funded by both the US Army and US Air Force and was known for it's disk shape which looked very much like a scaled-up modem “Frisbee” toy. Dr. Moller has several designs, his most notable being his M200x, U.S. Pat. No. 3,410,507, for it's flying saucer disk shape and use of multiple engines. Which lead to his series of small ducted fan UAVs, known as Aerobots, U.S. Pat. No. 4,795,111, using a single fan or eight ducted fans, powered by rotary engines. The Airborne Remotely Operated Device (AROD) was a small ducted fan vertical-take-off-and-landing (VTOL) developed by Moller as a subcontractor to Perceptronics, was electrically powered, with power supplied trough a tether from the ground station. Which has inspired Helicopter UAVs like the HoverCam can hover over a fixed spatial point and takeoff and land vertically but have limitations when operating in confined areas due to the exposed rotors rotating above the fuselage. And the Bell/Boeing Eagle Eye Tilt Rotor UAV, a scaled down versoin and derivative of the Bell/Boeing V-22 Osprey. In 1991 the HOVTOL UAV, U.S. Pat. No. 5,890,441, demonstrates twin high power engines capable of both vertical and horizontal flight using ducted fans primarily for vertical lift. And the Bombardier CL-327 Guardian VTOL UAV in 1996. It features dual, coaxial, contra-rotating, three bladed rotors. Its design is an evolution of the CL-227

Sentinel, and a follow-on concept, the CL427 Puma has been proposed. In the late 1980s, Sikorsky Aircraft flew a small doughnut-shaped UAV named Cypher, U.S. Pat. No. 5,575,438, that was based on coaxial-rotor technology developed by the company in the early 1970s. The Cypher was clearly a flying platfomn in general concept. The doughnut-shaped shroud not only improved safety in handling the machine, it also helped increase lift. The Cypher II, U.S. Pat. No. 6,270,038, is of similar size to its predecessor, but has a pusher propeller along with its rotor and can be fitted to a configuration with wings for long-range reconnaissance missions.

Other than the electric motor tethered AROD, built by Dr. Moller, all past VTOLs, manned or unmanned, have delt with loud fuel burning engines as the means of propulsion and the weight issues that go with them. Which seperates all others from the curent invention which uses new commercially available light weight quiet low voltage linear induction magnetic bearings simular to those used for monorails. To however, the MAGLEV monorails requires less power than its air conditioning equipment. Most new rollercoasters use LIM/LSM: LIM (Linear Induction Motor) and LSM (Linear Synchronous Motor) the two variations of electmagnetic propulsion. They replace a traditional lift hill and do not contain any moving parts. Typically LIM/LSM systems launch the roller coaster from the station extremely quickly the fasest at 0-100 in 7 seconds. The high energy density and rugged design of motors allows their use in demanding installations requiring high duty cycle, high power, rapid acceleration, improved speed and increased performance. Position sensing and control techniques allow for exremely precise control of acceleration and deceleration to permit the safe transport of sensitive or file loads. The lack of moving parts and wearing elements (no brushes or sliding contacts) in these motors greatly increases their reliability.

### DESCRIPTION

Summary of Invention

The aircraft is made up of 4 primary parts, the top cap of the main body, the propellerdisk (or impellerdisks), the main body (fuselage) and the bottom vane assembly, all built out of a light weight durable composite material. The main cargo area is created by the top cap and the center cone of the main body.

The aircraft a magnetic levitation (maglev) bearing system to suspend the propellerdisk (or impellerdisks) between the top cap and the main body at all times. The magnetic bearing system is created by a series of permanent magnet rings, located on the top cap, the propellerdisk (or impellerdisk) and the main body.

A linear induction magnetic power drive is located in the outer edge of the propellerdisk (or impellerdisks), reacting to linear induction acuators located in the main body, which is used to rotate the propellerdisk (or impellerdisks).

Vertical lift in the aircraft is produced by the propellerdisk (or impellerdisks) driving a column of air downwardly, through an annular thrust-flow channel which is formed in the main body of the aircraft.

The annular thrust-flow channel is provided with a flow control vented mechanism at the bottom which is capable of directing the developed air flow in varying orientations between a substantially vertical (axial) orientation for developing stationary, vertical lift (i.e., hovering) and a vectored (angled) orientation for developing a vertical component for producing lift and a horizontal component for producing forward (or rearward) flight.

The aircraft's main body also has an aerodynamic shape which is capable of developing lift responsive to forward flight using fins and rudders.

The power drive runs on light weight batteries, with a variety of optional rechargers, by linear generators, by pape thin solar panels on the body of the aircraft or an external battery charger. The battery industry, which is being driven by the electric transportation and portable consumer electronics industres, is making a substantial investment in battery technology. We will closely monitor the state of the art and will utilize the best available technology when the system design is finalized. Promising technologies include: nickel metal hydride, lithium-ion, and zinc-air.

Hybred variations will include liquid fuel boosterjets in the propellerdisk (or impellerdisks) to gain increased power during vertical take off, which will increase flight endurance.

Unmanned surveillance airciaf will use a standardized teleoperation system (STS) & standardized robotic system (SRS) to control flight & manage audio/video infomufon. Payload consists of the sensor suite, onboard controller, communications, and battery power pack. All communication between the platform and the control station passes though the mission payload.

The body shape and size of the aircraft is determined by the size and weight of the maglev power drive which is determined by the cargo (batteries, remote control servos, cpu and cameras).

Advantages of Invention

VTOL UFOs use linear induction magnetic bearings (LIMB) which are ideally suited for propulsion where as they provide superior value compared to other tradional types (ie. gasoline fueled engines and jet turbines). Value is a function of the following.

Lightweight— A LIMB power drive can weigh less than 1/20 of a conventional engine.

High Reliability— With magnetic bearings there is no contact between the rotating and stationary parts, meaning there is no wear. These components have design lives far greater than that of conventional bearings and engines. Magnetic bearings are providing high reliability and long service intervals in time critical applications in semiconductor manufactuin, vacuum pumps, and natura gas pipeline compression equipment.

Clean Power— In a magnetic bearing system, poluting exhuast, particle generation due to wear and the need for lubrication are eliminated. There is no gas, oil, grease or solid particles.

High Speed— The fact that a rotor spins in space without contact with the stator means drag on the rotor is minimal. That opens up the opportunity for die bearing to run at exceptionally high speeds, where the only limitation becomes the yield strength of the rotor material. Magnetic bearings have been designed with surface speeds up to 250 m/s or 4.5 million DN, where DN is the diameter of the rotor (mm) times the rotational spend (rpm). In order to achieve one quater of this kind of speed with conventional bearings, a complex lubrication system is requrred. No other type of bearing, can match magnetic bearings for shear speed.

Position and Vibration Control— Magnetic bearings use advanced control algoritm to influence the motion of the shaft and therefore have the inherent capability to precisely control the position of the shaft within microns and to virtually eliminate vibrations.

Extrme Conditions— The magnetic bearing system, is capable of operating through an extremely wide temperature range. Some have applications as low as −256° C. and as high as 220° C., thus allowing operation where tranditional bearings will not function. Magnetic bearings can also operate in vacuum where their operation is even more efficient due to lack of windage.

### BRIEF DESCRIPTION OF DRAWINGS

FIG. 1A is an exploded cut away perspective view of a single propellerdisk, an embodiment of a VTOL UFO according to the present invention. FIG. 1b is the compiled cut away perspective view of FIG. 1a showing the top of the fuselage (2), the propellerdisk (1), the bottom of the fuselage (3), the vane assembly (4) and how they relate to each other.

FIG. 2A is an exploded cut away perspective view of a single impellerdisk, an embodiment ofa VTOL UFO according to the present invention. FIG. 2b is the compiled cut away perspective view of FIG. 2a showing the top of the fuselage (2), the impropellerdisk (1), the bottom ofthe fuselage (3), the vane assembly (4) and how they relate to each other.

FIG. 3A is an exploded cut away perspective view of a single impellerdisk with liquid fuel jets, an embodiment of a VTOL UFO according to the present invention. FIG. 3b is the cross section view of FIG. 3a showing the linear induction maglev bearing(16), battery asssembly (18a), variable pitch motors (18b), linear generators (18c) and how they relate to each other. FIG. 3c is the cross section view of FIG. 3a showing the liquid fuel jets.

FIG. 4A is a lower rear perspective view of a single propellerdisk, an embodiment of an unmanned VTOL UFO according to the present invention. FIG. 4b is the top view of FIG. 4a. FIG. 4c is the side view of FIG. 4a. FIG. 4d is the front view of FIG. 4a. FIG. 4e is an upper front perspective view of FIG. 4a.

FIG. 5A is a side view of a single propellerdisk, an embodiment of a manned VTOL UFO according to the present invention, displaying the cockpit access ladder assembly (13). FIG. 5b is an upper rear perspective view of FIG. 5 at and FIG. 5c is an upper front perspective view of FIG. 5a.

FIG. 6A is a lower rear perspective view of a pair of vertically joined counter rotating impellerdisks, an embodiment of an unmanned VTOL UFO according to the present invention, displaying a hoverbot configuration. FIG. 6b is the top view of FIG. 6a. FIG. 6c is the side view of FIG. 6a. FIG. 6d is the front view of FIG. 6a. FIG. 6e is an upper front perspective view of FIG. 6a.

FIG. 7A is a lower front perspective view of a pair of joined counter rotating impellerdisks, an embodiment of an unmanned VTOL UFO according to the present invention, displaying a hoverbot configuration. FIG. 7b is the top view of FIG. 7a. FIG. 7c is the side view of FIG. 7a. FIG. 7d is the front view of FIG. 7a. FIG. 7e is an upper rear perspective view of FIG. 7a.

FIG. 8A is a lower fiont perspective view of a pair of joined counter rotating impellerdisks, an embodiment of a manned VTOL UFO according to the present invention, displaying a hoverboard configuration with a handlebar flight control assembly (21). FIG. 8b is the top view of FIG. 8a. FIG. 8c is the side view of FIG. 8a. FIG. 8d is the front view of FIG. 8a. FIG. 8e is an upper rear perspective view of FIG. 8a.

FIG. 9A is a lower front perspective view of a pair of joined counter rotating impellerdisks, an embodiment of a manned VTOL UFO according to the present invention, displaying a hoverbike configuration with a handlebar flight control assembly (21). FIG. 9b is the top view of FIG. 9a. FIG. 9c is the side view of FIG. 9a. FIG. 9d is the front view of FIG. 9a. FIG. 9e is a side perspective view of FIG. 9a.

FIG. 10A is a lower front perspective view of a pair of joined counter rotating impellerdisks, an embodiment of a manned VTOL UFO according to the present invention, displaying a hoverpod configuration with a cockpit (14). FIG. 10b is the top view of FIG. 10a. FIG. 10c is the side view of FIG. 10a. FIG. 10d is the fiont view of FIG. 10a. FIG. 10e is an upper rear perspective view of FIG. 10a.

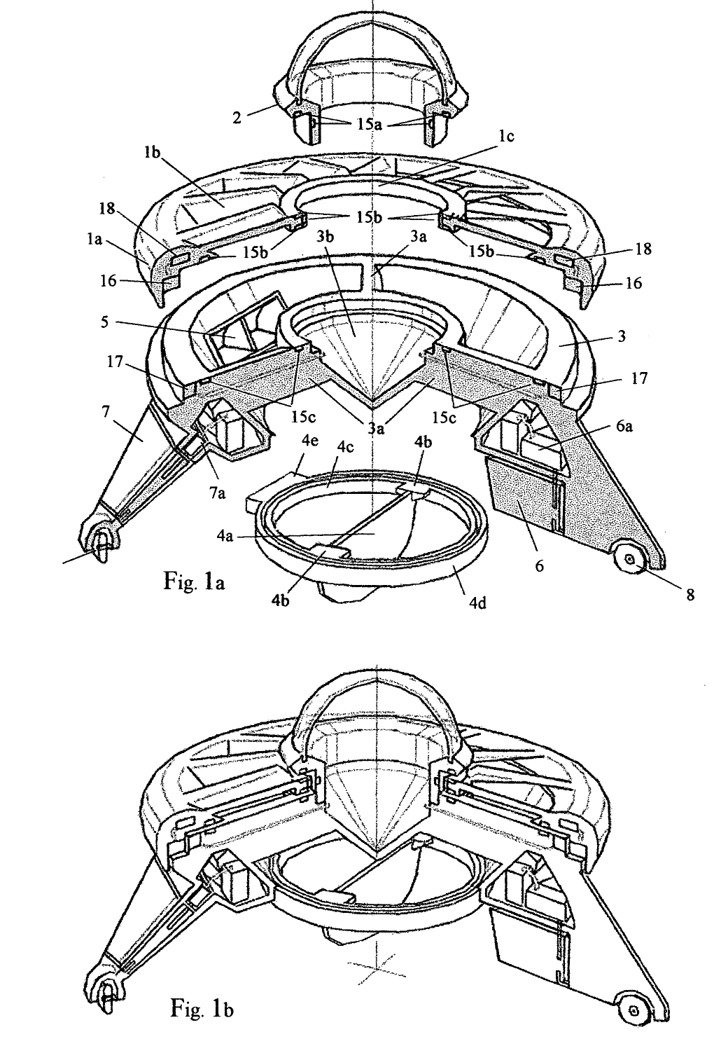

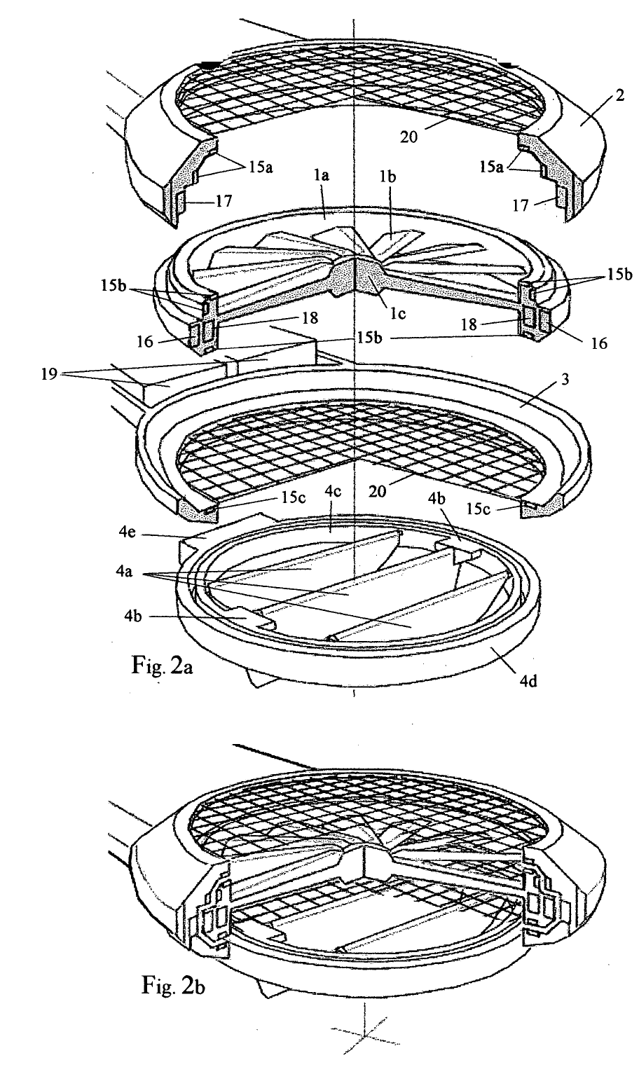

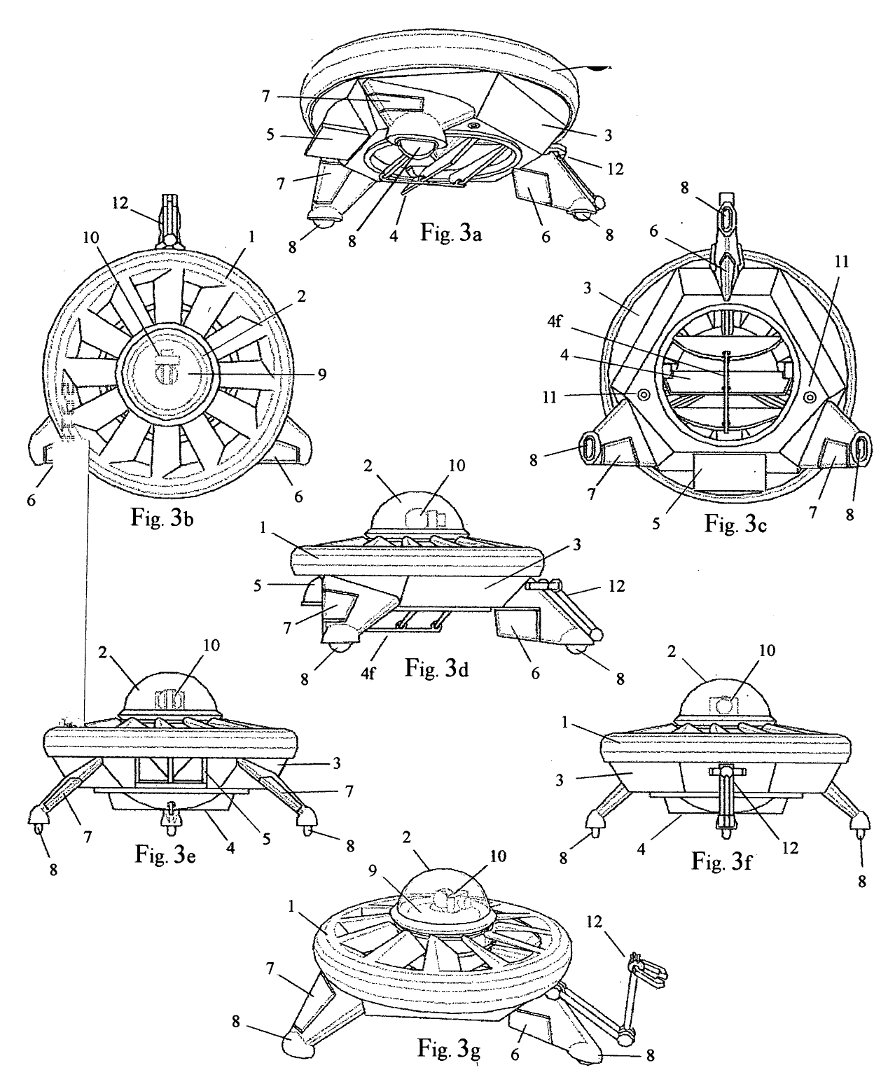

FIG. 1A is a lower rear perspective view of three joined impellerdisks, an embodiment of a manned VTOL UFO according to the present invention, displaying an aisle configuration with a cockpit (14). FIG. 11b is the top view of FIG. 11a. FIG. 11c is the side view of FIG. 11a. FIG. 11d is the front view of FIG. 11a. FIG. 11e is an upper front perspective view of FIG. 11a.

FIG. 12A is a lower rear perspective view of four joined counter rotating impropellerdisks, an embodiment of a manned VTOL UFO according to the present invention, displaying an aircraft configuration with a cockpit (14). FIG. 12b is the top view of FIG. 12a. FIG. 12c is the side view of FIG. 12a. FIG. 12d is the fiont view of FIG. 12a. FIG. 12e is an upper front perspective view of FIG. 12a.

FIG. 13A is a lower rear perspective view of five joined impellerdisk, an embodiment of a manned VTOL UFO according to the present invention, displaying an aircraft configuration with a cockpit (14). FIG. 13b is the top view of FIG. 13a. FIG. 13c is the side view of FIG. 13a. FIG. 13d is the front view of FIG. 13a. FIG. 13e is an upper front perspective view of FIG. 13a.

FIG. 14A is a lower rear perspective view of six joined impellerdisk, an embodiment ofa manned VTOL UFO according to the present invention, displaying an aircraft configuration with a cockpit (14). FIG. 14b is the top view of FIG. 14a. FIG. 14c is the side view of FIG. 14a. FIG. 14d is the front view of FIG. 14a. FIG. 14e is an upper front perspective view of FIG. 14a.

### DETAILED DESCRIPTION OF THE PREFERRED EMBODIMENTS

Referring now to the drawings wherein like reference characters identify corresponding or smilar elements throughout the several views ofthe embodiments of the invention. FIG. 1 illustrates cut away perspective views, exploded and compiled, of one embodiment, using a single propellerdisk unmanned VTOL UFO according to the present invention. It includes a single propellerdisk (1), comprising of an outer discoidal ring (1a), a series of fixed propeller blades (1b), or a series of varitable pitch propeller blades (1c) attached to the outer ring eminating from an inner hub ring (1c). The outer discoidal ring (1a) houses a permanent magnet ring (15b) used to levitate the propellerdisk a fraction of an inch from a permanent magnet ring (15c) in the fuselage (3). The outer discoidal ring (1a) also houses the linear induction magnetic bearing (16) used to rotate the propellerdisk reacting to the linear induction actuator ring (17) in the fuselage (3). The outer discoidal ring (1a) also houses a ring of batteries or a custom battery ring (18a), varitable pitch motors (18b), and linear generators (18c) used to recharge the batteries. The outer discordal ring also houses optional liquid fuel ram jet assemblies made up of fuel tanks (6a), intake vents (6b), combustion nossles (6c), and exhaust vents (6d). The inner hub ring (1c) houses three permanent magnet rings (15b) used to levitate the propellerdisk a fraction of an inch from two permanent magnet rings (15a) in the top cap of the fuselage (2) and a permanent magnet ring (15c) in the fuselage (3).

These permanent magnet rings (15a-c), which require no power, make up the bearing system needed to levitate the propellediskl at all times including non-operation of the VTOL UFO. The top cap of the fuselage, in this unmanned single propellerdisk embodiment is made up of a tinted plexiglass dome and a bottom ring that houses the two permanent magnet rings (15a). The top cap (2) attaches to the center cone (3b) of the main body of the fuselage (3) to create the permanent magnet bearing system. The area created within the top cap (2) and the center cone (3b) is the cargo area housing the central processing unit and battery assembly (9) and camera assembly (10). The central processing unit (9) controls all camera and flight control functions via a remote link (1e) to the linear induction magnetic bearing (16) and hard wire connections, emunating from the center cone (3b) through the hollowed struts (3a) connected to the inner wall of the outer toroidal fuselage (3), communicating with the linear induction actuator ring (17), the flight control stabilizer fins servos and batteries (7a), the rear vent servos and batteries (5), the bottom vane assembly servos and batteries (4b and 4e) and additional camera assemblies (11) all located in the toroidal fuselage (3). The bottom vane assembly's outer ring (4d) is attached to the fuselage at the bottom opening of the toroidal duct. A servo (4e) rotates the inner vane ring (4c) and a second servo (4b) rotates at least one vane (4a), (option, upto three vanes as shown in drawings) to redirect the developed air flow in any direction. Rear vent assemblies (5) are located at rear of the toroidal fuselage to aid in forward thrust when opened. The VTOL UFO also has at least two attached wings with pivotable portions (7), used for flight control, which are combined with the pivoting landing gear, pontoons or rails (8). An optional telerobotic arm (12) could be attached to the front of the fuselage for special missions.

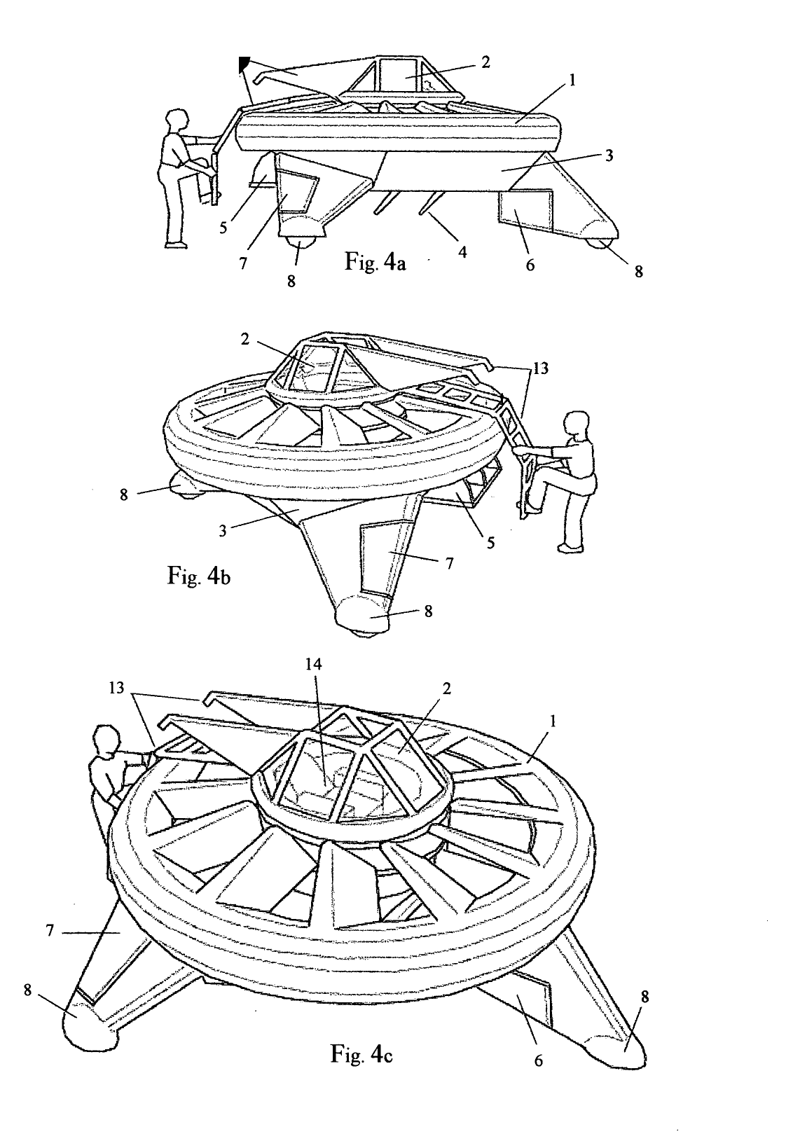

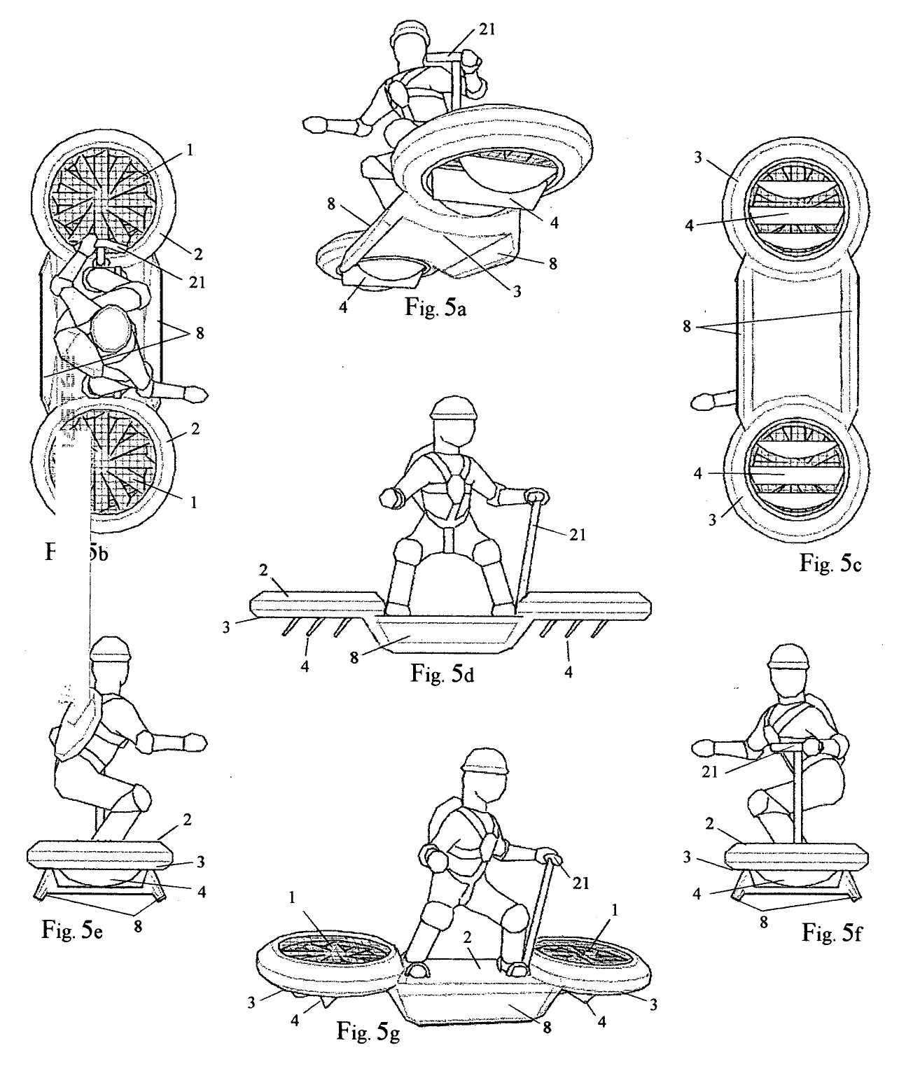

A ladder assembly (13) is demonstrated in FIG. 4A-C for entering the cockpit (14) of a manned single propellerdisk embodiments of the invention.

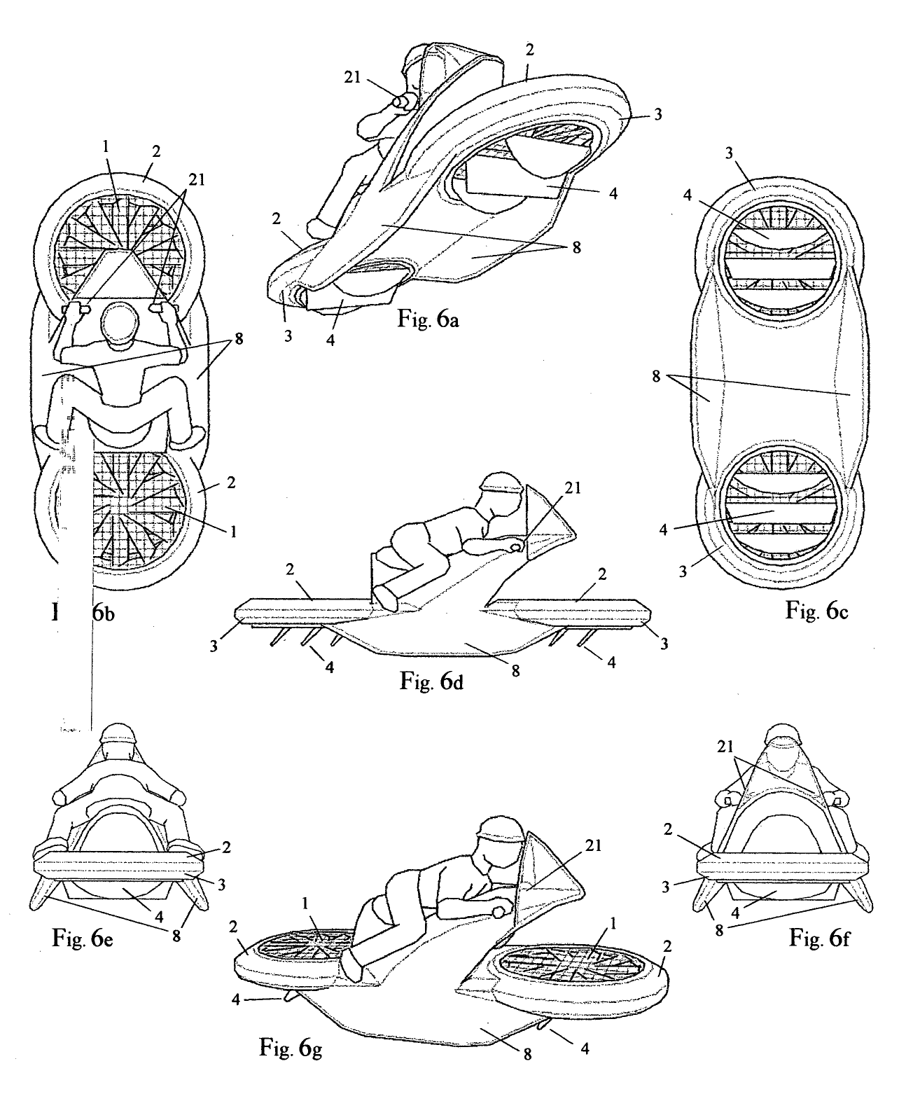

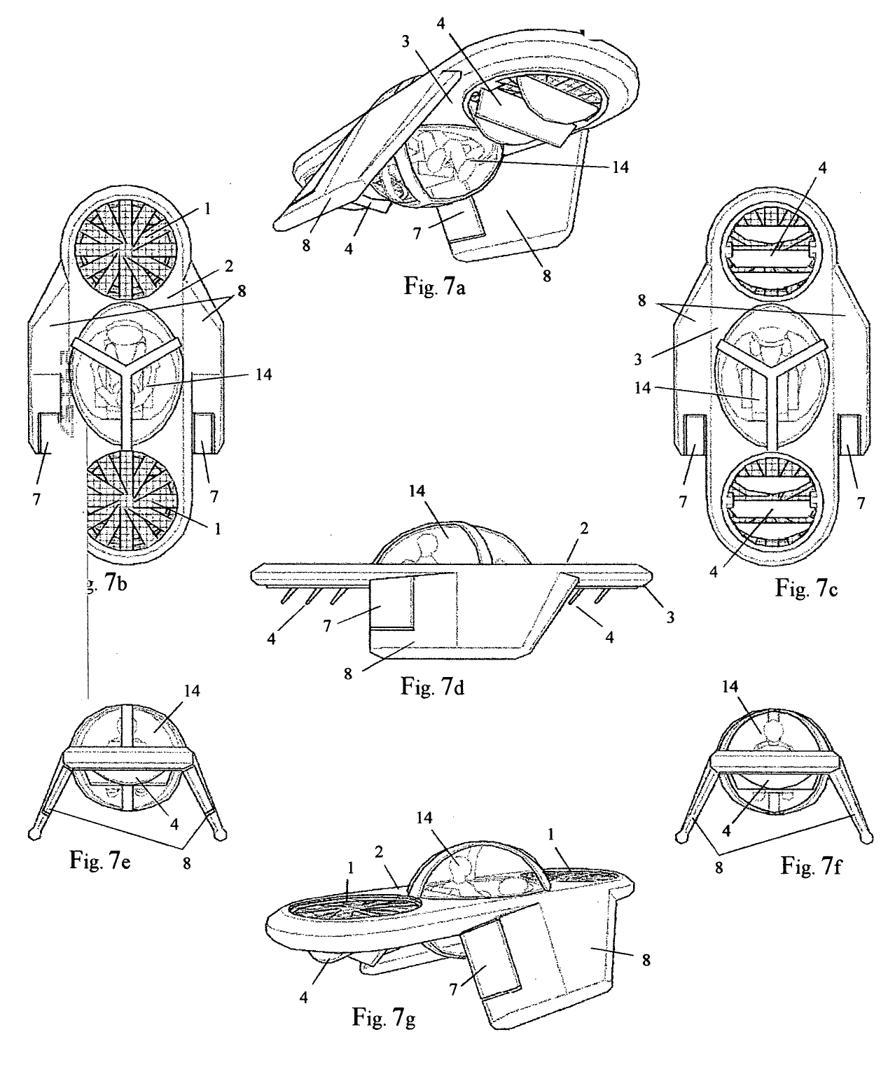

Other embodiments of the VTOL UFO demontrate how multiple counter rotating propellerdisks can be joined by creating modular shrouded impellenderdisks, in a variety of configurtions combining them either vertically as shown in FIG. 6a-e, or horizontally as shown in FIG. 7a-e. The center cone (3b of FIG. 1) is eliminated placing the cargo areas/payloads inbetween the horizontally joined impellerdisks. Instead of the top cap (2) and bottom fuselage (3) joining in the center hub, they now join around the outside crating a shrouded body around the impellerdisks (1), which now has a closed hub. Optional protective screens (20) can be added to the top and bottom openings of the toroidal duct.

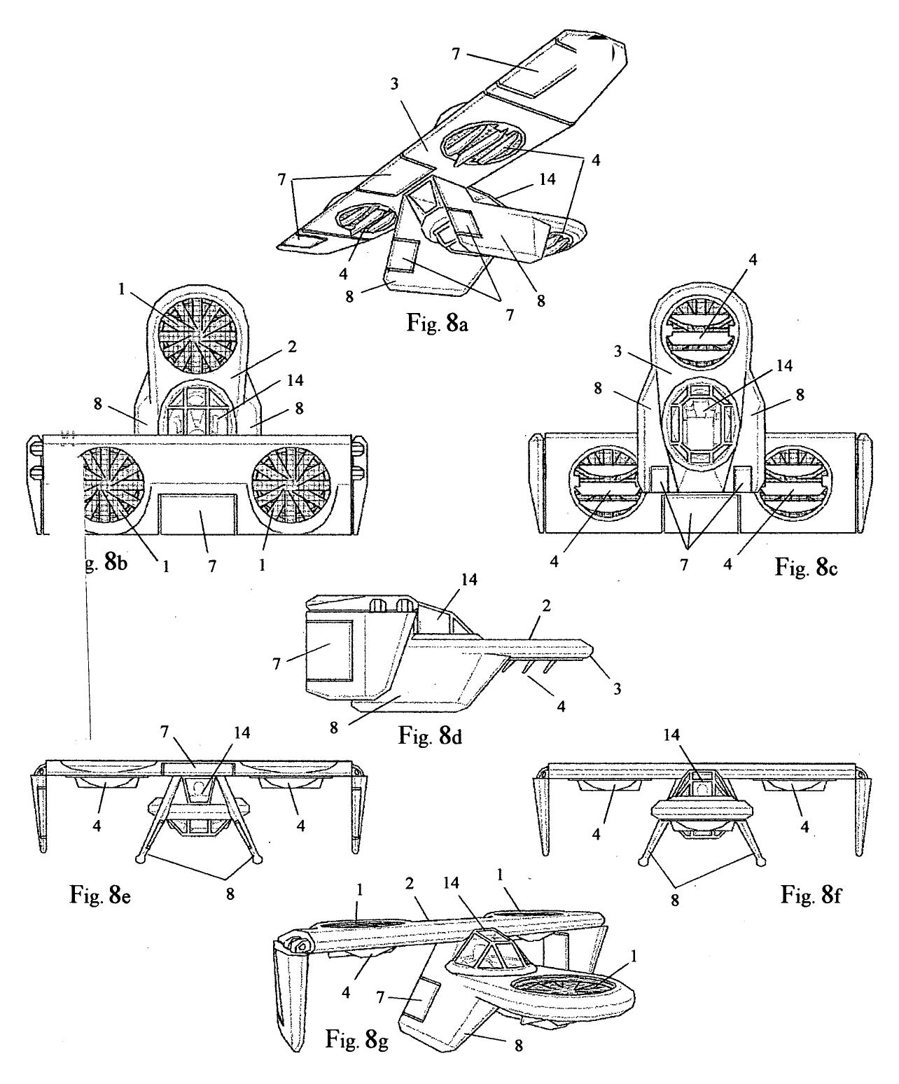

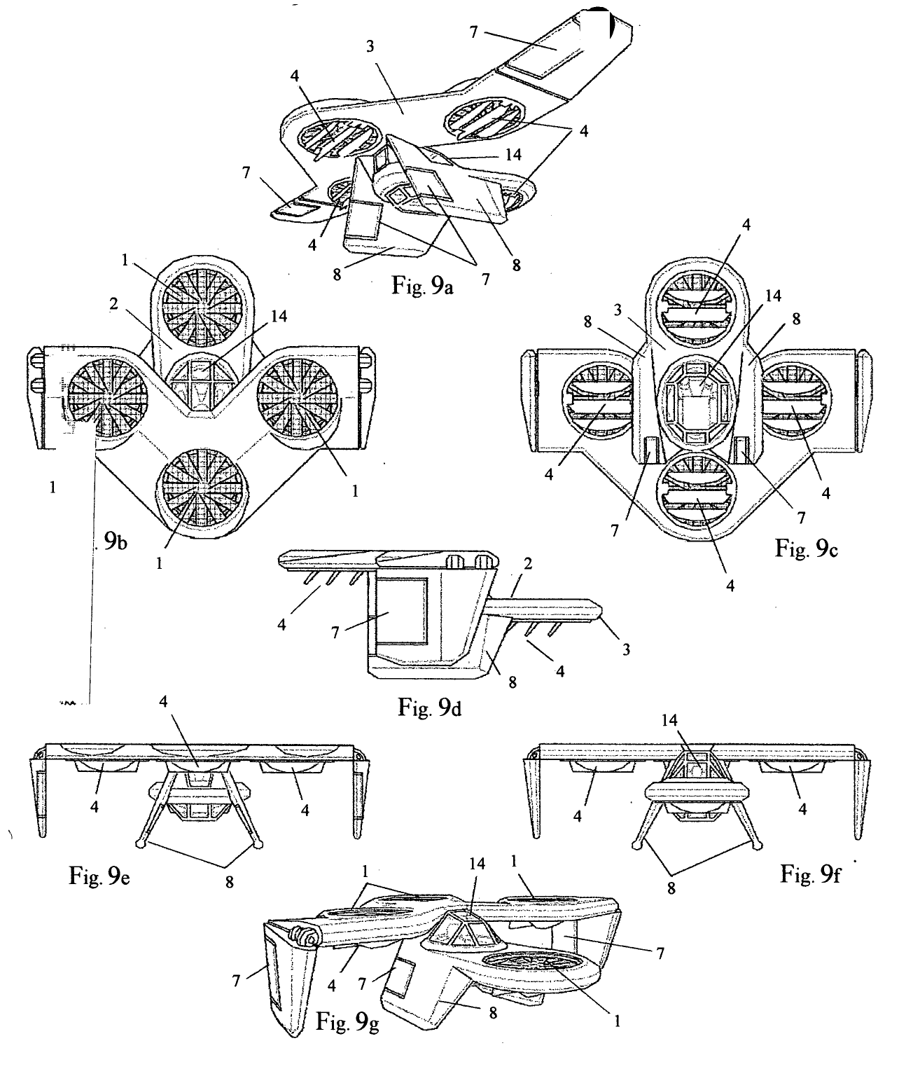

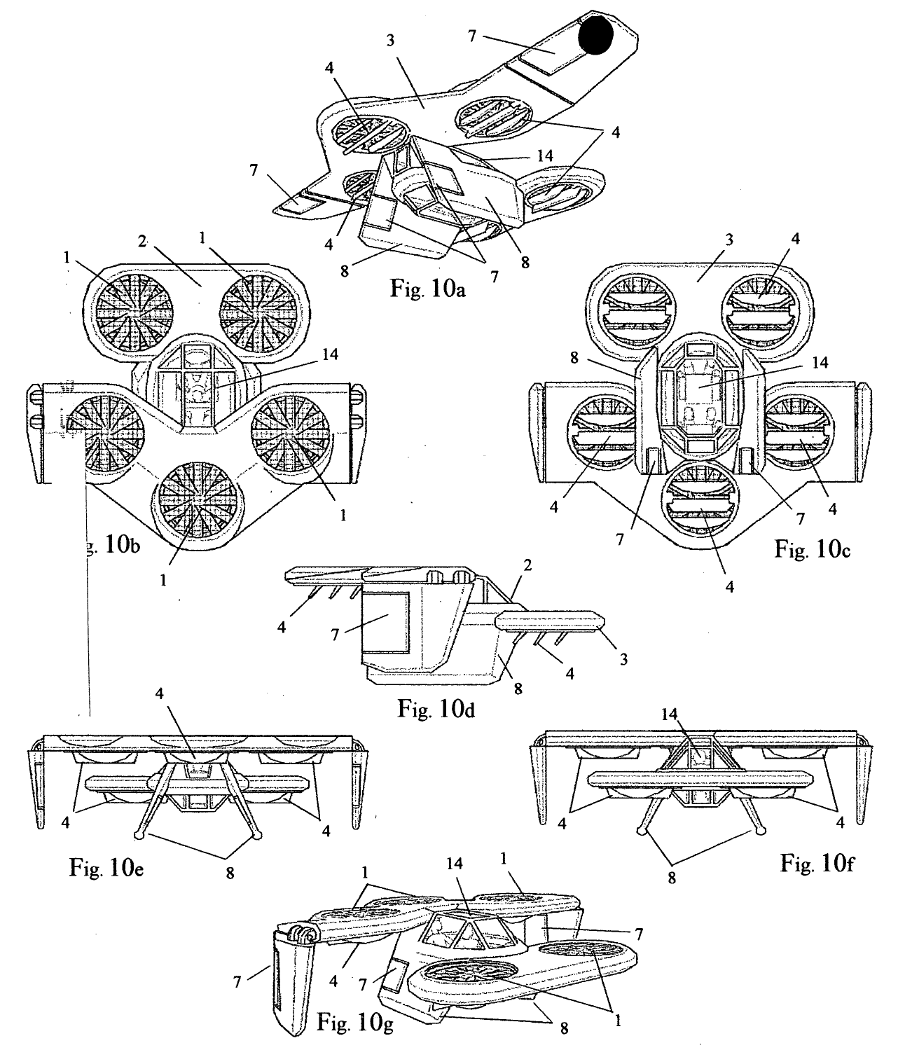

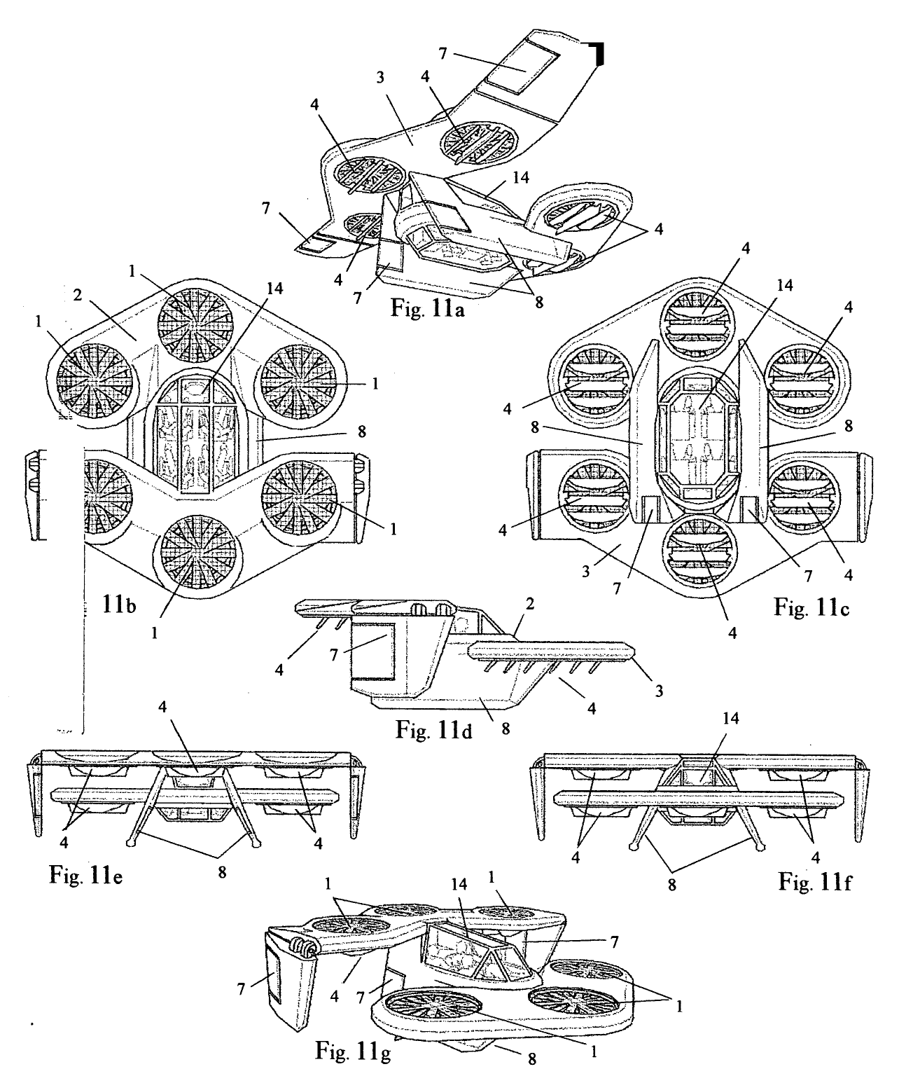

Variations of multiple shrouded impellerdisks are demonstrated in FIG. 8a-e, FIG. 9a-e, FIG. 10a-e, FIG. 11a-e, FIG. 12a-e, FIG. 13a-e, and FIG. 14a-e. Some of which include foldable wing tips with pivotable portions (7) used for added flight control joystick fly-by-wire flight controls (21), and or cockpits (14).

In addition to the VTOL UFO embodiments described and claimed above, in accordance with alternate embodiments of the invention, scaled up and/or down versions of any of the embodiments heretofore described may be employed for recreational or surveilance purposes, whether or not human subjects are conveyed thereupon or being used as remote controled UAVs. The described embodiments of the invention are intended to be merely exemplary and numerous variations and modifications will be apparent to those skilled in the art. All such variations and modifications are intended to be within the scope of the present invention as defined.

What is claimed is:

1. A VTOL UFO comprising:
a fuselage having a partial toroidal body having a top, front, rear and bottom ends and a duct, or ducts, extending between the top and bottom surfaces, the fuselage having a longitudial axis,
a propellerdisk and means, or a series of shrouded impellerdisks and means located in said duct, or ducts, for rotation about its axis, drive means to provide lift for said aircraft the propellerdisk, or impellerdisks, having a plurality of fixed or variable pitch blades eminating from a central hub to an outer discoidal ring
a senes ofthre hollowed support struts eminating from an inner cone out to the inner wall of the toroidal body for supporting a cone shaped cargo area within the duct and house power and communication cables on embodiments having a single propellerdisk,
a vane system located in line with said duct below said propellerdisk, or impellerdisks, for controlling the diection of the developed air flow from said bottom openings,
at least a pair of fixed or rotating wings attached to said fuselage, at least a portion of the wings being pivotable with respect to the fuselage for flight control,
a landing gear, wheels, pontoons or rails attacthed to said fuselage.

2. A VTOL UFO of claim 1, comprising: an electric power drive, said drive means comprises: a series of permanant magnets in a bearing system to levitate said propellerdisk, or impellerdisks, at all times and a computer controlled linear induction magnetic bearing located in outter ring of said propellerdisk, or impellerdisks reacting to linear actuators located in said fuselage, used to rotate said propellerdisk, or impellerdisks and provide lift.

3. A VTOL UFO of claim 1 comprising: vents located at said rear end of embodiunents using a single propellerdisk, with means for opening and closing to provide horizontal thrust for use in moving said aircraft in a forward direction.

4. A VTOL UFO according to claim 1 wherein the wings include a fixed or rotating portion, and wherein the pivotable portion is a flaperon which is hingedly attached to the aft of the fixed portion and is pivotable with respect to it.

5. A VTOL UFO according to claim 4 further comprising a servo actuator mounted within the fixed portion and engaged with the flaperon for controlling its actuation.

6. A VTOL UFO according to claim 1 further comprising at least one directional vane assembly mounted to and within the shroud downstrem from the blades, the directional vane assembly having an outer ring and inner ring bearing being pivotable with respect to the shroud for providing directional control over the flow exiting the duct. At least one adjustable vane with means is connected to the rotatable inner ring for providing additional directional control over the flow exiting the duct.
